(19) United States
(12) Patent Application Publication
(10) Pub. No.: US 2018/0144498 A1
(43) Pub. Date: May 24, 2018

(54) POSITION DETECTION DEVICE, PROCESSING APPARATUS, AND COMPUTER PROGRAM PRODUCT

(71) Applicant: Kabushiki Kaisha Toshiba, Minato-ku (JP)

(72) Inventors: Atsushi SUGAHARA, Kawasaki (JP); Haruna Eto, Arakawa (JP); Kazuma Komoda, Fuchu (JP); Akihito Ogawa, Fujisawa (JP)

(73) Assignee: Kabushiki Kaisha Toshiba, Minato-ku (JP)

(21) Appl. No.: 15/687,956

(22) Filed: Aug. 28, 2017

(30) Foreign Application Priority Data
Nov. 18, 2016 (JP) 2016-225447

(51) Int. Cl. G06T 7/73; G06T 7/60; G06T 7/50; G06T 7/90; G06T 7/11

(52) U.S. Cl. CPC G06T 7/74; G06T 7/60; G06T 7/50; G06T 7/90; B25J 9/1697; G06T 2207/10024; G06T 2207/20021; G06T 2207/10028; G06T 7/11

(57) ABSTRACT

A position detection device according to an embodiment includes a pitch acquisition unit and a position detection unit. The pitch acquisition unit acquires a pitch at which target objects are arranged, based on a spectral analysis performed on captured image data of the target objects. The position detection unit detects positions of the target objects based on the pitch.

### CROSS-REFERENCE TO RELATED APPLICATIONS

This application is based upon and claims the benefit of priority from Japanese Patent Application No. 2016-225447, filed on Nov. 18, 2016; the entire contents of which are incorporated herein by reference.

### FIELD

An embodiment described herein relates generally to a position detection device, a processing apparatus, and a computer program product.

### BACKGROUND

Devices that deal with articles based on image data including a plurality of articles have been known.

It is advantageous, for example, to provide a novel device that can detect the positions of target objects based on image data with fewer shortcomings.

### BRIEF DESCRIPTION OF THE DRAWINGS

FIG. 1 is a schematic and exemplary perspective view illustrating a general configuration of a system including a position detection device and a processing apparatus according to an embodiment;

FIG. 2 is an exemplary block diagram illustrating a general configuration of the position detection device according to the embodiment;

FIG. 3 is a schematic and exemplary perspective view of a plurality of target objects to be dealt with by the position detection device according to the embodiment;

FIG. 4 is a schematic and exemplary diagram illustrating an image of a target region determined by the position detection device according to the embodiment and corresponding to some of the target objects illustrated in FIG. 3;

FIG. 5 is a graph illustrating a result of a spectral analysis performed by the position detection device according to the embodiment on image data of the target region in the case of FIGS. 3 and 4;

FIG. 6 is a schematic and exemplary perspective view of a plurality of target objects to be dealt with by the position detection device according to the embodiment in a state different from the state in FIG. 3;

FIG. 7 is a schematic and exemplary diagram illustrating an image of a target region determined by the position detection device according to the embodiment and corresponding to some of the target objects illustrated in FIG. 6;

FIG. 8 is a graph illustrating results of spectral analyses performed by the position detection device according to the embodiment on image data of the target region in the case of FIGS. 6 and 7;

FIG. 9 is a diagram illustrating correction of an image by a target region correction unit of the position detection device according to the embodiment;

FIG. 10 is a schematic and exemplary diagram illustrating an image of the target region in FIG. 4 from which images inside segments are deleted by the position detection device according to the embodiment; and

FIG. 11 is a flowchart illustrating an example of the procedure performed by the position detection device according to the embodiment.

### DETAILED DESCRIPTION

A position detection device according to an embodiment includes a pitch acquisition unit and a position detection unit. The pitch acquisition unit acquires a pitch at which target objects are arranged, based on a spectral analysis performed on captured image data of the target objects. The position detection unit detects positions of the target objects based on the pitch.

The following discloses an exemplary embodiment according to the present invention. The configuration and control (technical features) in the embodiment to be described below and functions and results (effects) provided by the configuration and the control are presented for illustrative purposes only. The illustrative examples and modifications below contain like constituent elements. In the following description, common reference signs refer to like constituent elements, and duplicate explanations thereof are omitted.

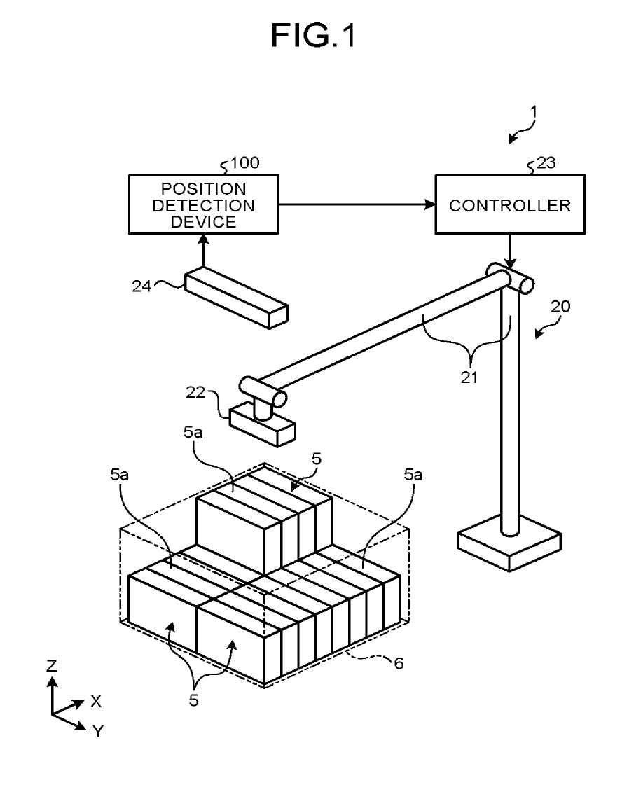

FIG. 1 is a perspective view illustrating a general configuration of a picking system 1. As illustrated in FIG. 1, the picking system 1 includes a picking apparatus 20, a controller 23, a sensor 24, and a position detection device 100.

The picking apparatus 20 includes a movable member 21 and a gripping mechanism 22. The picking apparatus 20 conveys a target object 5 by moving the movable member 21 with the gripping mechanism 22 gripping the target object 5. The picking apparatus 20 is, for example, an articulated robot arm, and the gripping mechanism 22 is, for example, a vacuum chuck, but they are not limited to these examples. The picking apparatus 20 is an example of a processing apparatus. The movable member 21 and the gripping mechanism 22 are an example of a processing unit.

A plurality of target objects 5 are stacked in tiers in a receptacle 6, and each tier includes a plurality of target objects 5 arranged in rows and columns. The receptacle 6 is, for example, a box, a container, or a palette, and the target objects 5 are, for example, articles packed in a box package, but they are not limited to these examples. For the convenience of the following description, the directions in which the target objects 5 are arranged in each tier are referred to as an X direction and a Y direction, and the direction in which the target objects 5 are stacked is referred to as a Z direction.

The picking apparatus 20 includes actuators (not illustrated). The controller 23 electrically controls the actuators to control the operation of the picking apparatus 20. The actuators are, for example, motors, pumps including motors, solenoids, or electromagnetic valves including solenoids, but they are not limited to these examples.

The controller 23 controls the actuators in accordance with position data acquired from the position detection device 100 to move the gripping mechanism 22 to a certain position. The position data detected by the position detection device 100 may indicate the positions of the target objects 5 or the position of the gripping mechanism 22. The gripping mechanism 22 is an example of the processing unit.

The position detection device 100 detects the positions of the target objects 5 based on image data acquired by the sensor 24. The position detection device 100 may be, for example, a computer or a board. The configuration and operation of the position detection device 100 will be described later.

The sensor 24 is, for example, a three-dimensional distance image sensor such as an RGB-depth (D) sensor. In other words, the sensor 24 can output both image data and distance data. The sensor 24 may be an image sensor (camera) such as a complementary metal-oxide-semiconductor (CMOS) image sensor or a charge-coupled device (CCD) image sensor. The picking system 1 may include a plurality of sensors, or include both a sensor for detecting distances and a sensor for acquiring an image, as the sensor 24. Alternatively, the sensor 24 or the target objects 5 (receptacle 6) may be movably configured and the sensor 24 may acquire image data by scanning the target objects 5.

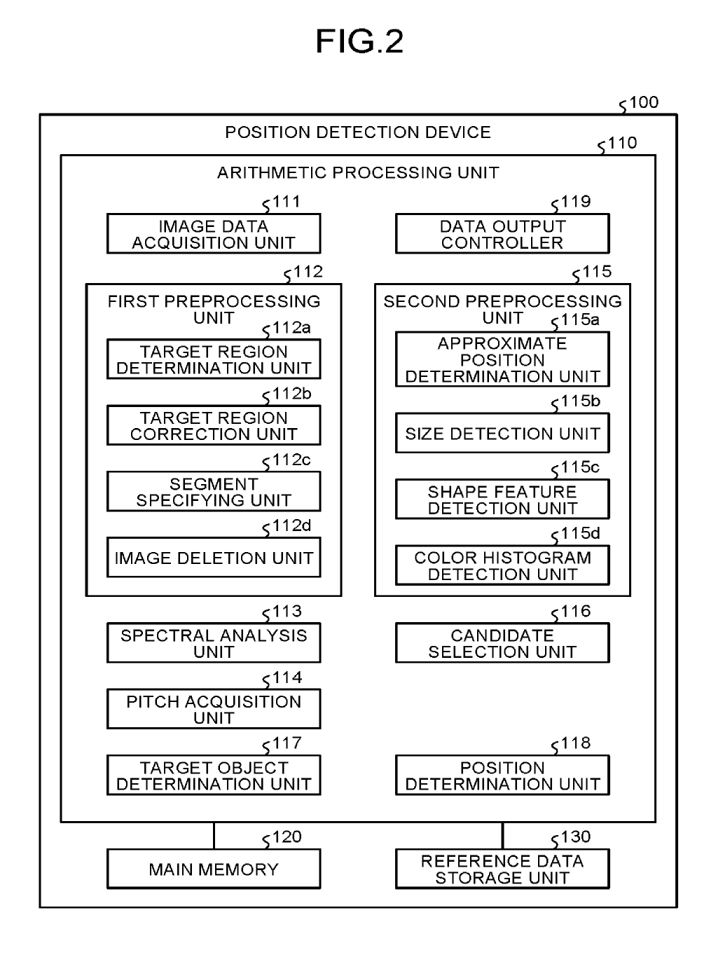

FIG. 2 is a block diagram illustrating a general configuration of the position detection device 100. As illustrated in FIG. 2, the position detection device 100 includes, for example, an arithmetic processing unit 110, a main memory 120, and a reference data storage unit 130. The arithmetic processing unit 110 is, for example, a central processing unit (CPU) or a controller, the main memory 120 is, for example, a read only memory (ROM) and a random access memory (RAM), and the reference data storage unit 130 is, for example, a hard disk drive (HDD), a solid state drive (SSD), or a flash memory. The reference data storage unit 130 is an example of an auxiliary storage device. The reference data storage unit 130 is an example of a database.

The arithmetic processing and control performed by the arithmetic processing unit 110 may be implemented by using software or hardware. The arithmetic processing and control performed by the arithmetic processing unit 110 may include arithmetic processing and control by software and arithmetic processing and control by hardware. When the arithmetic processing and control are implemented by software, the arithmetic processing unit 110 reads a computer program (application) stored in, for example, the ROM, HDD, SSD, or flash memory therefrom and executes the computer program.

The arithmetic processing unit 110 operates in accordance with the computer program to function as the units included in the arithmetic processing unit 110, that is, to function as an image data acquisition unit 111, a first preprocessing unit 112, a spectral analysis unit 113, a pitch acquisition unit 114, a second preprocessing unit 115, a candidate selection unit 116, a target object determination unit 117, a position determination unit 118, and a data output controller 119, for example. In this case, the computer program includes modules corresponding to these units.

The computer program may be recorded and provided in a computer-readable recording medium such as a compact disc read only memory (CD-ROM), a flexible disk (FD), a compact disc recordable (CD-R), a digital versatile disc (DVD), and a universal serial bus (USB) memory as an installable or executable file. The computer program may be stored in a storage unit of a computer connected to a communication network and installed by being downloaded via the network. The computer program may be previously embedded in the ROM, for example.

When all of or part of the arithmetic processing unit 110 is configured by hardware, the arithmetic processing unit 110 may include a field programmable gate array (FPGA) or an application specific integrated circuit (ASIC), for example.

The image data acquisition unit 111 acquires image data from the sensor 24. When the sensor 24 is a three-dimensional distance image sensor, the data acquired by the image data acquisition unit 111 includes, for example, data indicating distances (positions) of the pixels in the Z direction at the respective locations as well as RGB image data. The three-dimensional distance image data may be referred to as three-dimensional point cloud data or three-dimensional point cloud image data.

The first preprocessing unit 112 performs preprocessing for the process performed by the spectral analysis unit 113. The first preprocessing unit 112 includes, for example, a target region determination unit 112a, a target region correction unit 112b, a segment specifying unit 112c, and an image deletion unit 112d.

The target region determination unit 112a determines a target region to be processed by the spectral analysis unit 113 from the acquired image data.

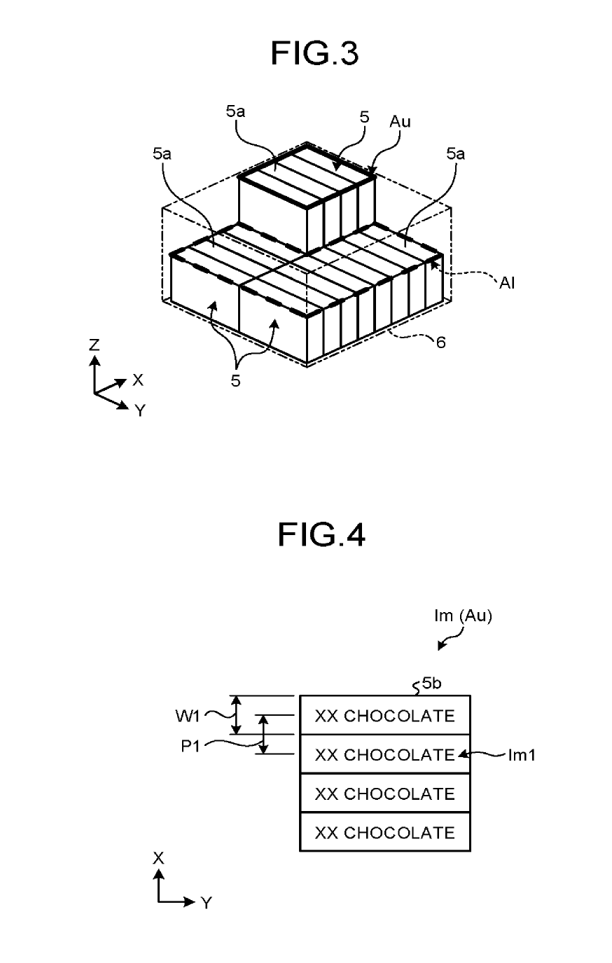

FIG. 3 is a perspective view of a plurality of target objects 5. The target objects 5 stacked in tiers are captured by the sensor 24 provided thereabove, and the captured image data includes, as illustrated in FIG. 3, a region Au (point cloud) including top faces 5a of a plurality of target objects 5 located at the upper tier and a region Al (point cloud) including top faces 5a of a plurality of target objects 5 located at the lower tier. In this case, the target region determination unit 112a determines the upper region Au to be a target region. The reason for this is that the gripping mechanism 22, which is located above the target objects 5 as illustrated in FIG. 1, can more smoothly pick and convey a target object 5 located at the upper tier first than taking out a lower one.

Specifically, when the image data includes, for example, more pixels (point cloud, pixels corresponding to the region Al) than a threshold in a certain range at a first height level and more pixels (point cloud, pixels corresponding to the region Au) than the threshold in a certain range at a second height level higher than the first height level, the target region determination unit 112a determines the region Au in the certain level at the higher second height level to be the target region.

FIG. 4 illustrates a two-dimensional image Im of the region Au determined to be the target region in the case of FIG. 3. The image Im includes an outline 5b of the target objects 5 and images Im1, such as characters or patterns, depicted on the top faces 5a. The outline 5b is, for example, the shadow of the target objects 5 generated by light from a light source (not illustrated).

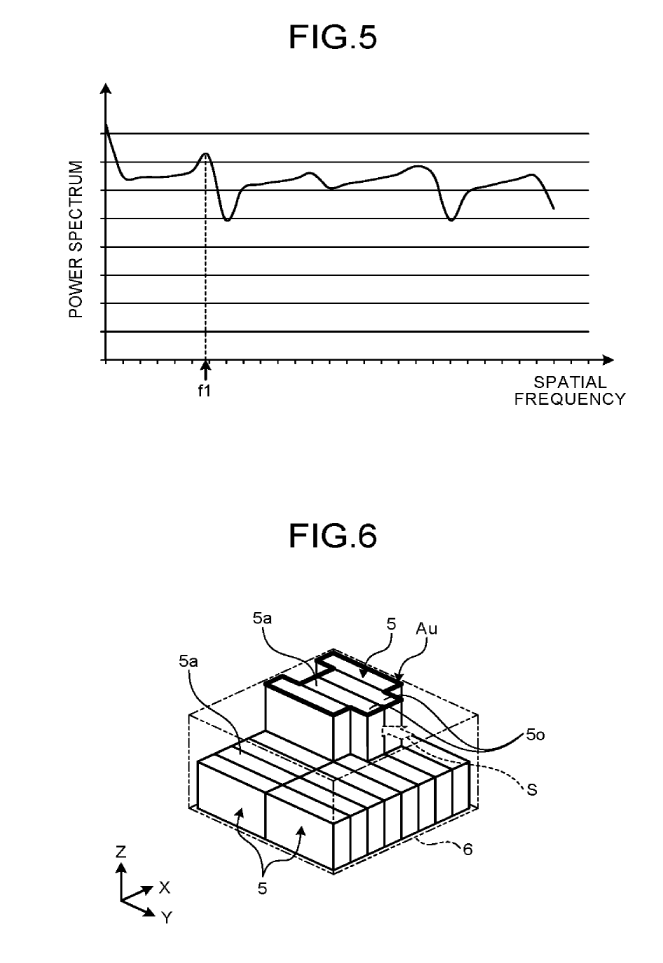

FIG. 5 is a graph illustrating a result of a spectral analysis on the image data of the target region in the case of FIGS. 3 and 4. In FIG. 5, the horizontal axis represents spatial frequency and the vertical axis represents power spectrum. The spectral analysis unit 113 performs a spectral analysis on the data of the two dimensional image Im of the region Au. This spectral analysis provides a result as illustrated in FIG. 5, for example. The spectral analysis is, for example, the Fourier transform (discrete Fourier transform) or the cosine transform (discrete cosine transform). The pitch acquisition unit 114 acquires, from the result of the spectral analysis, a pitch P1 corresponding to the highest peak value in terms of the power spectrum within a certain range of cycles, that is, acquires a pitch P1 (=1/f1) corresponding to a spatial frequency f1 having the highest peak power spectrum value in FIG. 5. When a plurality of target objects 5 is arranged at regular intervals as illustrated in FIGS. 3 and 4, the pitch at which the target objects 5 are arranged generally corresponds to the highest peak in the result of the spectral analysis on the image data of the target region acquired as described above. When the adjacent target objects 5 are arranged in contact with each other as illustrated in FIGS. 3 and 4, the pitch P1 of the target objects 5 in a certain direction (X direction) matches a width W1 (size) of a target object in the certain direction as illustrated in FIG. 4. With this configuration, the position detection device 100 can estimate the positions of the target objects 5 based on the pitch P1.

The spectral analysis unit 113 may perform a multi-dimensional (two-dimensional) Fourier transform. Performing a spectral analysis in two orthogonal directions (X direction and Y direction) in which the target objects 5 are arranged in a plane may allow the spectral analysis unit 113 to acquire pitches at which the target objects 5 are arranged in the two directions. The spectral analysis unit 113 may perform the spectral analysis a plurality of times by changing the directions, and the pitch acquisition unit 114 may acquire a peak value from a result of the spectral analysis performed in a direction exhibiting the highest peak value.

The target region correction unit 112b (FIG. 2) included in the first preprocessing unit 112 corrects the target region, on which the spectral analysis unit 113 performs processing.

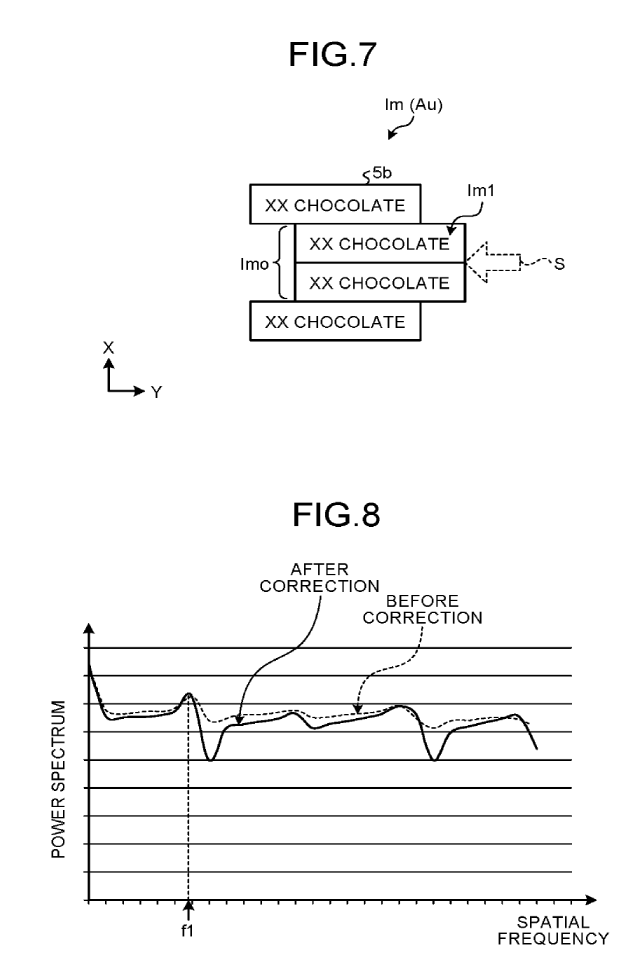

FIG. 6 is a perspective view of a plurality of target objects 5 in a state different from the state in FIG. 3. FIG. 7 is a two-dimensional image Im of the region Au determined to be the target region in the case of FIG. 6. FIG. 8 is a graph illustrating results of spectral analyses on image data of the target region in the case of FIGS. 6 and 7 and on image data of a corrected target region. When the target objects 5 are arranged in the X direction with some target objects 5o being shifted in the Y direction as illustrated in FIG. 6, the two-dimensional image Im of the region Au contains a portion Imo shifted in the Y direction as illustrated in FIG. 7. The result of the spectral analysis in such a case may exhibit a less steep peak as indicated by the dashed line in FIG. 8. In this case, the accuracy of estimation by the pitch acquisition unit 114 may degrade.

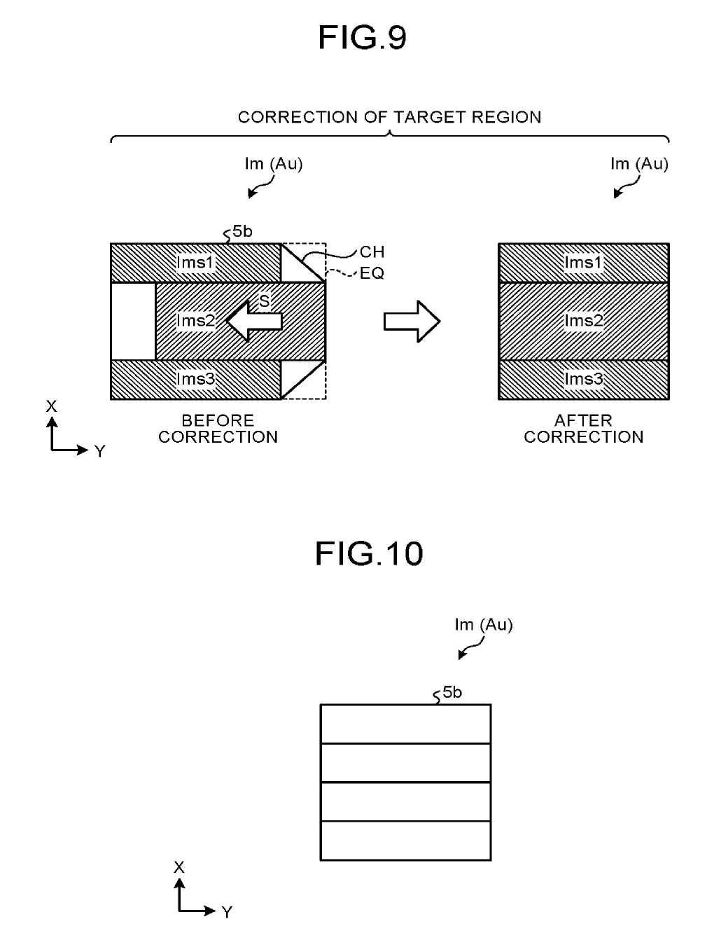

FIG. 9 is a diagram illustrating correction of an image by the target region correction unit 112b. When the region Au determined to be the target region is not rectangular and has a recessed or a protruding portion in the X direction or the Y direction, the target region correction unit 112b segments the two-dimensional image Im of the region Au into a plurality of rectangular subregions Ims1 to Ims3. The subregions Ims1 to Ims3 each have a rectangular shape having sides along the X direction and sides along the Y direction. The subregion Ims2 is shifted in the Y direction relative to the other subregions Ims1 and Ims3, and the target region correction unit 112b corrects the image Im of the region Au such that it shifts the subregion Ims2 in an S direction (opposite direction of the Y direction) to arrange (align) the subregions Ims1 to Ims3 in the X direction to make a rectangular region Au. Correcting the image Im leads to a sharper peak as indicated by the solid line in FIG. 8, which may improve the accuracy of estimation by the pitch acquisition unit 114.

The target region correction unit 112b may perform correction based on a comparison between a minimum circumscribing rectangle EQ and a convex hull CH of the two-dimensional image Im of the region Au before correction. The target region correction unit 112b can distinguish the subregions Ims1 and Ims3 (subregions to be shifted in the correction) that create a difference between the minimum circumscribing rectangle EQ and the convex hull CH in the Y direction from the subregion Ims2 (subregion not to be shifted in the correction) that creates no difference therebetween.

The same effect can be obtained by performing an actual aligning operation on the target objects 5. To perform such an aligning operation when shifted target objects 5 are detected as illustrated in FIGS. 6 and 7, the position detection device 100 outputs data indicating the position and the amount of the shift to the controller 23. The controller 23 then controls the movable member 21 in accordance with the data acquired from the position detection device 100 to move the target objects 50 corresponding to the shifted subregion Ims2 in the S direction (opposite direction of the Y direction) illustrated in FIGS. 6 and 7, thereby aligning the target objects 5 in the X direction. The alignment operation of the picking apparatus 20 under the control of the controller 23 can be performed based on the positions and shape of the target objects 5, and thus can be performed on target objects 5 that have not been identified. The picking apparatus 20 may push the shifted target objects 5 with the gripping mechanism 22 or with a part or a member other than the gripping mechanism 22. The target region correction unit 112b is an example of a target region segmentation unit, and the movable member 21 is an example of a movable unit.

When the two-dimensional image Im of the region Au determined to be the target region includes the images Im1 (e.g., characters or patterns) depicted on the top faces 5a as illustrated in FIGS. 4 and 7, the periodic feature of the illustration of the images Im1 may be an obstacle to detecting the pitch of the target objects 5. To prevent this situation, the first preprocessing unit 112 includes the segment specifying unit 112c and the image deletion unit 112d as illustrated in FIG. 2. The segment specifying unit 112c specifies the outline 5b (segments) of the target objects 5. To specify the outline 5b, the segment specifying unit 112c may perform YC separation on the image of the region Au, that is, may separate the image data into the luminance signal and color signal, and the segment specifying unit 112c may specify a portion having a low luminance value as the outline 5b. The image deletion unit 112d deletes the images Im1 inside the specified outline 5b. FIG. 10 is a diagram illustrating a two-dimensional image Im from which the images Im1 depicted on the top faces 5a in FIG. 4 have been deleted. Correcting the two-dimensional image Im of the region Au determined to be the target region in such a manner may improve the accuracy of estimation by the pitch acquisition unit 114. The image deletion unit 112d can be considered as an example of the target region correction unit.

The second preprocessing unit 115 (FIG. 2) performs preprocessing for pattern matching or preprocessing for selecting reference data (reference value, candidate) for use in the pattern matching. The position detection device 100 can detect the positions and the size of the target objects 5 based on the pitch acquired by the pitch acquisition unit 114. In order for the position detection device 100 to detect the positions and the size of the target objects 5 more accurately in the present embodiment, the candidate selection unit 116 compares data (hereinafter referred to as detected data) obtained from the detection result of the sensor 24 with a plurality of pieces of reference data of a plurality of target objects 5 previously stored in the reference data storage unit 130, and selects a candidate having a high similarity to the detected data from the reference data of the target objects 5. The target object determination unit 117 and the position determination unit 118 compare the reference data of the selected candidate with image data (image data of the target region) acquired by the image data acquisition unit 111. If the degree of matching is equal to or larger than a certain threshold, the target object determination unit 117 specifies the selected candidate as the target objects 5 to be processed and the position determination unit 118 determines the positions each having a high degree of matching to the reference data of the candidate to be the positions of the target objects 5. The reference data storage unit 130 may be provided external to the position detection device 100. In this case, the arithmetic processing unit 110 can acquire the reference data through a communication network.

The second preprocessing unit 115 includes, for example, an approximate position determination unit 115a, a size detection unit 115b, a shape feature detection unit 115c, and a color histogram detection unit 115d.

The approximate position determination unit 115a determines approximate positions of the target objects 5 based on the pitch P1 (see FIG. 4) acquired by the pitch acquisition unit 114. When, for example, the positions (representative positions) of the target objects 5 are located at the center (center of gravity) of each segment defined by the outline 5b in the two-dimensional image Im, the representative positions of the target objects 5 located at the respective ends in the X direction of a column of the target objects 5 along the X direction are located a distance (P1)/2 (i.e., a half pitch) away from the outline 5b in the X direction. In the column of the target objects 5 along the X direction, the target objects 5 (the representative positions of the target objects 5) are arranged at the pitch P1 in the X direction. The approximate position determination unit 115a is an example of a position detection unit.

The size detection unit 115b can detect the width W1 (size, see FIG. 4) having substantially the same value as the pitch P1 as described above. When partitions are provided between the target objects 5, the width W1 has a smaller value than the pitch 21.

The shape feature detection unit 115c detects, for example, the shape feature of each segment defined by the outline 5b in the two-dimensional image Im of the region Au determined to be the target region. Examples of the shape feature may include typical specifications such as a shape, dimensions, and an aspect ratio of each segment, and include a local feature such as the blob feature, corner feature, oriented FAST and rotated BRIEF (ORB) feature, and accelerated KAZE (AKAZE) feature.

The color histogram detection unit 115d detects, for example, a color histogram of each segment defined by the outline 5b in the two-dimensional image Im of the region Au determined to be the target region.

The reference data storage unit 130 stores therein, for example, reference data of the width W1 (size), reference data of the shape feature, reference data of the color histogram, and reference data of an image for use in pattern matching (reference image data, template) for each of a plurality of target objects 5.

The candidate selection unit 116 compares the detected data with the corresponding reference data with respect to the size, the shape feature, and the color histogram, and selects a target object 5 having the highest similarity as the candidate.

The reference data, for example, is sectioned in accordance with the size range. In this case, the candidate selection unit 116 may compare the detected data with reference data included in a section corresponding to the size of the detected data. This configuration can reduce the number of pieces of reference data to be compared with the detected data, and thus, the candidate selection unit 116 can perform the processing more rapidly.

The candidate selection unit 116 calculates similarities in accordance with a known method of multi-dimensionally vectorizing a plurality of parameters, and selects, as a candidate, a target object 5 having the highest similarity among a plurality of pieces of reference data. The candidate selection unit 116 is an example of a target object specifying unit.

The target object determination unit 117 and the position determination unit 118 acquire image data of the target object 5 selected as a candidate from the reference data storage unit 130 as reference image data. The target object determination unit 117 and the position determination unit 118 perform pattern matching on the two-dimensional image Im of the region Au determined to be the target region by using the reference image data. For example, the position determination unit 118 performs the pattern matching at a plurality of locations near the approximate positions acquired by the approximate position determination unit 115a by, for example, spirally scanning the reference image data. The position determination unit 118 determines positions each having a similarity equal to or larger than a certain value and having the highest position to be the positions of the target objects 5. The target object determination unit 117 determines the candidate to be the target objects 5 when the similarity obtained in the pattern matching is equal to or larger than a certain value. The target object determination unit 117 and the position determination unit 118 may be referred to as a pattern matching processing unit. The position determination unit 118 is an example of the position detection unit.

The data output controller 119 outputs, for example, data of the position detected by the position determination unit 118 and data indicating the shifted position and the amount of the shift detected by the target region correction unit 112b to the controller 23.

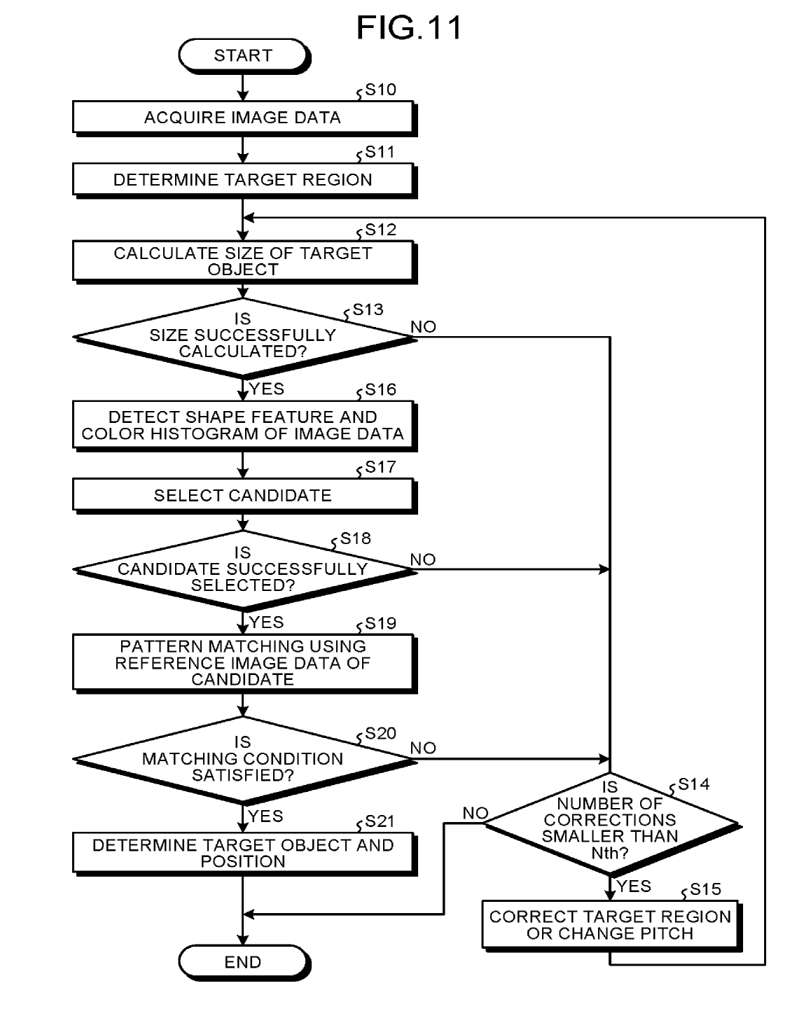

FIG. 11 is a flowchart illustrating the procedure performed by the position detection device 100. As illustrated in FIG. 11, the arithmetic processing unit 110 first functions as the image data acquisition unit 111 to acquire image data from the sensor 24 (S10).

The arithmetic processing unit 110 then functions as the target region determination unit 112a to determine a target region of the image data (S11).

The arithmetic processing unit 110 functions as the spectral analysis unit 113, the pitch acquisition unit 114, and the size detection unit 115b to detect the size of the target objects 5 in accordance with the result of the spectral analysis on the target region (S12).

If the arithmetic processing unit 110 fails to detect a size or a pitch that satisfies a certain condition at S12 (No at S13), and if the accumulated number of corrections or peak changes performed at S15 to this point is smaller than a threshold Nth (e.g., five times) (Yes at S14), the arithmetic processing unit 110 functions as the target region correction unit 112b or the image deletion unit 112d to correct the target region. Alternatively, the arithmetic processing unit 110 functions as the pitch acquisition unit 114 to acquire another peak value, that is, acquires a different pitch corresponding to another peak, as the pitch of the target objects 5 (S15). In this case, processing at and after S12 is performed by using the corrected target region or the pitch. If No at S14, the procedure of the arithmetic processing is ended.

If the arithmetic processing unit 110 successfully detects a size that satisfies the certain condition at S13 (Yes at S13), the arithmetic processing unit 110 functions as the shape feature detection unit 115c and the color histogram detection unit 115d to detect the shape feature and color histogram of the target region in the image data (S16).

The arithmetic processing unit 110 then functions as the candidate selection unit 116 and compares detected data with reference data with respect to, for example, the size, shape feature, and color histogram to select, from a plurality of target objects 5, a target object 5 that has a similarity equal to or larger than a certain value and having the highest similarity as a candidate (S17).

If the candidate selection unit 116 fails to select a candidate that satisfies a certain condition at S17 (No at S18), and if the accumulated number of processing at S15 is smaller than the threshold Nth (Yes at S14), the arithmetic processing unit 110 functions as the target region correction unit 112b or the image deletion unit 112d to correct the target region. Alternatively, the arithmetic processing unit 110 functions as the pitch acquisition unit 114 to acquire another peak value, that is, acquires a different pitch corresponding to another peak, as the pitch of the target objects 5 (S15). In this case, processing at and after S12 is performed by using the corrected target region or the pitch.

If the candidate selection unit 116 successfully selects a candidate that satisfies the certain condition at S17 (Yes at S18), the arithmetic processing unit 110 functions as the target object determination unit 117 and the position determination unit 118 to perform pattern matching by using the reference image data of the candidate (S19).

If a certain matching condition is satisfied at S19 (Yes at S20), the target object determination unit 117 determines the candidate satisfying the matching condition to be the target objects 5, and the position determination unit 118 determines positions each satisfying the matching condition and having the highest similarity to be the positions of the target objects 5 (S21).

If the certain matching condition is not satisfied at S20 (No at S20), and if the accumulated number of processing at S15 is smaller than the threshold Nth (Yes at S14), the arithmetic processing unit 110 functions as the target region correction unit 112b or the image deletion unit 112d to correct the target region. Alternatively, the arithmetic processing unit 110 functions as the pitch acquisition unit 114 to acquire another peak value, that is, acquire a different pitch corresponding to another peak, as the pitch of the target objects 5 (S15). In this case, processing at and after S12 is performed by using the corrected target region or the pitch.

In the cases of No at S13, No at S18, and No at S20, the target region correction unit 112b or the image deletion unit 112d, or the pitch acquisition unit 114 may perform different types of processing at S15 for the respective cases.

In the present embodiment, as described above, the pitch acquisition unit 114 acquires a pitch at which the target objects 5 are arranged in accordance with the result of the spectral analysis performed on image data, and the approximate position determination unit 115a and the position determination unit 118 detect the positions of the target objects 5 based on the pitch. According to the present embodiment, for example, the pitch and the size of the arranged target objects 5 can be acquired more easily or more rapidly.

In the present embodiment, the position determination unit 118 (position detection unit) detects the positions of the target objects 5 based on pattern matching on the image data by using reference image data of the target object 5 selected as the candidate by the candidate selection unit 116 (target object specifying unit). According to the present embodiment, for example, the positions of the target objects 5 can be detected more accurately.

In the present embodiment, the candidate selection unit 116 (target object specifying unit) determines a candidate target object 5 based on a comparison between detected data of the shape feature obtained from the image data and reference data of the shape feature stored in the reference data storage unit 130. According to the present embodiment, for example, the target object 5 (candidate target object 5) can be specified more accurately.

In the present embodiment, the candidate selection unit 116 (target object specifying unit) determines a candidate target object 5 based on a comparison between detected data of the color histogram obtained from the image data and reference data of the color histogram stored in the reference data storage unit 130. According to the present embodiment, for example, the target object 5 (candidate target object 5) can be specified more accurately.

In the present embodiment, the target region correction unit 112b segments the region Au (target region) into a plurality of rectangular subregions Ims1 to Ims3 and corrects the shape of the region Au to a rectangular shape by shifting the subregions Ims1 to Ims3, to arrange the subregions Ims1 to Ims3 in a first direction, in a second direction intersecting the first direction. According to the present embodiment, for example, the spectral analysis for acquiring a pitch can be performed more accurately.

In the present embodiment, the image data is three-dimensional distance image data, and the target region determination unit 112a determines the target region based on distance data contained in the image data. According to the present embodiment, for example, when a processing target is determined in accordance with the distances from the sensor 24 to the target objects 5, the target region can be determined more rapidly and more properly.

In the present embodiment, the movable member 21 of the picking apparatus 20 moves the target objects 50 corresponding to the subregions Ims1 to Ims3 and aligns the target objects 50. According to the present embodiment, for example, the spectral analysis for acquiring a pitch can be performed more accurately.

The specific configurations or shape (e.g., structure, types, directions, shape, size, length, width, thickness, height, number, arrangement, positions, materials) may be changed as appropriate to implement the present embodiment. For example, the processing apparatus may be an apparatus that performs an operation other than picking (gripping, conveying), such as printing, typing, attaching labels, packaging, painting, machining, or mounting of parts.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A position detection device comprising:
a pitch acquisition unit configured to acquire a pitch at which target objects are arranged, based on a spectral analysis performed on captured image data of the target objects; and
a position detection unit configured to detect positions of the target objects based on the pitch.

2. The position detection device according to claim 1, further comprising:
a size calculation unit configured to calculate a size of each target object based on the pitch; and
a target object specifying unit configured to specify the target object based on a comparison between a calculated value of the size calculated by the size calculation unit and reference values of sizes of the target objects stored in a database, wherein
the position detection unit calculates the positions of the target objects based on pattern matching on the image data by using reference image data of the target object specified by the target object specifying unit.

3. The position detection device according to claim 2, further comprising:
a shape feature detection unit configured to detect a shape feature of an image from the image data, wherein
the target object specifying unit specifies the target object based on the comparison between the calculated value of the size and the reference values of the sizes and a comparison between a detected value of the shape feature detected by the shape feature detection unit and reference values of shape features of the target objects.

4. The position detection device according to claim 2, further comprising:
a color histogram detection unit configured to detect a color histogram of an image from the image data, wherein
the target object specifying unit specifies the target object based on the comparison between the calculated value of the size and the reference values of the sizes, and a comparison between a detected value of the color histogram detected by the color histogram detection unit and reference values of color histograms of the target objects.

5. The position detection device according to claim 1, further comprising:
a target region determination unit configured to determine a target region to be processed in the image data; and
a target region correction unit configured to segment the target region into rectangular subregions and correct a shape of the target region to a rectangular shape by shifting the subregions, to arrange the subregions in a first direction, in a second direction intersecting the first direction, wherein
the pitch acquisition unit acquires the pitch by performing a spectral analysis on the target region corrected by the target region correction unit.

6. The position detection device according to claim 1, further comprising:
a segment specifying unit configured to specify segments of the target objects in the image data; and
an image deletion unit configured to delete an image in the segments from the image data, wherein
the pitch acquisition unit acquires the pitch by performing a spectral analysis on the image data from which the image in the segments is deleted by the image deletion unit.

7. The position detection device according to claim 5, wherein
the image data is three-dimensional distance image data, and
the target region determination unit determines the target region based on distance data contained in the image data.

8. A processing apparatus comprising:
a processing unit configured to process the target objects based on positions of the target objects, the positions being calculated by the position detection device according to claim 1.

9. The processing apparatus according to claim 8, wherein the position detection device includes
a target region determination unit configured to determine a target region in the image data, and
a target region segmentation unit configured to segment the target region into the rectangular subregions,
the processing apparatus comprising a movable member configured to move the target objects corresponding to the subregions, to arrange the target objects corresponding to the target region in a first direction, in a second direction intersecting the first direction.

10. A computer program product having a non-transitory computer readable medium including programmed instructions, wherein the instructions, when executed by a computer, cause the computer to function as:
the position detection device according to claim 1, the position detection device comprising the pitch acquisition unit and the position detection unit.
